(19) United States
(12) Patent Application Publication
(10) Pub. No.: US 2025/0137139 A1
(43) Pub. Date: May 1, 2025

(54) METAL COMPOUND THIN FILM, METHOD OF FORMING THE SAME AND THIN FLIM CATALYST FOR WATER ELECTROLYSIS

(71) Applicant: NATIONAL SUN YAT-SEN UNIVERSITY, Kaohsiung (TW)

(72) Inventors: Chun-Hu CHEN, Kaohsiung (TW); Chun-Cheng HSU, Kaohsiung (TW)

(21) Appl. No.: 18/931,101

(22) Filed: Oct. 30, 2024

(30) Foreign Application Priority Data
Oct. 31, 2023 (TW) 112141841

(51) Int. Cl. C23C 18/16; B41M 3/00; B41M 5/00; B41M 7/00; C03C 17/22; C03C 17/25; C25B 11/052; C25B 11/067; C25B 11/075; C25B 11/077

(52) U.S. Cl. CPC C23C 18/161; B41M 3/001; B41M 3/008; B41M 5/0047; B41M 7/00; C03C 17/22; C03C 17/25; C23C 18/1639; C25B 11/052; C25B 11/067; C25B 11/075; C25B 11/0771; C03C 2217/228; C03C 2217/28; C03C 2218/119

(57) ABSTRACT

A metal compound thin film, a method of forming the same and a thin film catalyst for water electrolysis are provided. The method includes providing a substrate; and performing plural ink-jet printing operations to the substrate to form the metal compound thin film on the substrate. The substrate is a non-hydrophobic substrate. Each of the ink-jet printing operations includes depositing a first precursor on the substrate by using a first nozzle of an ink-jet system; and depositing a second precursor on the substrate by using a second nozzle of the ink-jet system. A chemical reaction occurs between the first precursor and the second precursor to form a metal compound, and the metal compound thin film includes plural layers of the metal compound. Therefore, patterning the thin film can be easily accomplished, and chemical solution can be effectively saved.

### CROSS-REFERENCE TO RELATED APPLICATION

This application claims priority to Taiwan Application Serial Number 112141841, filed Oct. 31, 2023, which is herein incorporated by reference.

### BACKGROUND

### Field of Invention

The present invention relates to a metal compound thin film and a method of forming the same. More particularly, the present invention relates to a metal compound thin film, a method of forming the same and a thin film catalyst for water electrolysis.

### Description of Related Art

Conventionally, common methods of growing thin films include chemical vapor deposition (CVD) and physical vapor deposition (PVD), but process cost is greater since CVD and PVD both need expensive equipment such as precision vacuum system. In addition, a solution deposition method (such as spin coating and dip coating) is also often used as a conventional method of growing thin film, but the aforementioned methods often need additional surfactants to control a thickness of the thin film. Thus, it is needed to remove the surfactants under high temperature, but the high temperature treatment may destroy the obtained thin film structure.

A metal compound thin film is usually formed by using two kinds or more kinds of precursor solutions. Conventionally, for example, the metal compound thin film is formed on a substrate with a roll-to-roll process by immersing the substrate with great area into the precursor solutions, but the aforementioned method needs to consume large amount of chemical solution. Moreover, in the method of immersing the substrate into the precursor solutions, composition of the precursor solution used and the metal compound formed on the substrate may change with process progressing; thus, a property of the metal compound thin film cannot be affectively controlled.

If patterning the metal compound thin film is performed, conventional method should combine a photoresist with a lithography process, in which the process is complicated and the cost is greater. In addition, specific metal compounds are not easy to be attached on the substrate directly, so it is needed to use high temperature process or addition of specific additives, thereby inducing the metal compound linking on the substrate. However, the high temperature process may limit selection of the substrate, and usage of the additives may limit applicability of the obtained metal compound thin film.

Therefore, it is needed to provide a method of forming a metal compound thin film to save the amount of the chemical solution, to affectively pattern the substrate, and to increase selection of the substrate and freedom of application.

### SUMMARY

An aspect of the present invention provides a method of forming a metal compound thin film, which forms the metal compound thin film by ink-jet printing operations.

Another aspect of the present invention provides a metal compound thin film.

Yet another aspect of the present invention provides a thin film catalyst for water electrolysis.

According to the aspect of the present invention, a method of forming a metal compound thin film is provided. The method includes providing a substrate; and performing at least one ink-jet printing operations to form the metal compound thin film on the substrate. The substrate is a non-hydrophobic substrate. The metal compound thin film includes at least a thin film pattern. Each of the ink-jet printing operations includes depositing a first precursor on the substrate by using a first nozzle of an ink-jet system; and depositing a second precursor on the substrate by using a second nozzle of the ink-jet system. A chemical reaction occurs between the first precursor and the second precursor to form a metal compound, and the metal compound thin film includes at least one layer of the metal compound.

According to an embodiment of the present invention, the substrate includes a silicon wafer, a metal substrate, a polymer substrate or combinations thereof.

According to an embodiment of the present invention, the method further includes performing a rinsing operation after every one to ten times of the ink-jet printing operations, wherein the rinsing operation includes washing the substrate with deionized water.

According to an embodiment of the present invention, the chemical reaction is an oxidation-reduction reaction, and oxidation potentials of the first precursor and the second precursor are different.

According to an embodiment of the present invention, each of the ink-jet printing operations further includes depositing at least a third precursor by using at least a third nozzle of the ink-jet system.

According to an embodiment of the present invention, a pH value of the first precursor and the second precursor is in a range between 0 and 7.

According to an embodiment of the present invention, a pH value of a mixture of the first precursor and the second precursor is in a range from 0 to 7 after depositing a second precursor on the substrate.

According to an embodiment of the present invention, the at least a thin film pattern includes plural rectangular blocks, the rectangular blocks have no contact with each other, and are arranged regularly or irregularly.

According to another aspect of the present invention, a metal compound thin film is provided. The metal compound thin film is formed by the method of the above aspect.

According to yet another aspect of the present invention, a thin film catalyst for water electrolysis, which includes the metal compound thin film of the above aspect, is provided.

According to the aspect of the present invention, a method of forming a metal compound thin film is provided. The method includes providing a substrate; performing plural ink-jet printing operations to form the metal compound thin film on the substrate; and performing a rinsing operation to the substrate with deionized water. The substrate is a hydrophilic substrate. The ink-jet printing operations includes depositing first precursors on the substrate by using a first nozzle of an ink-jet system; and depositing second precursors on the substrate by using a second nozzle of the ink-jet system, wherein a chemical reaction occurs between the first precursors and the second precursors to form metal compounds, and the metal compound thin film includes plural layers of the metal compound.

According to an embodiment of the present invention, the substrate includes a silicon wafer, a metal substrate, a polymer substrate or combinations thereof.

According to an embodiment of the present invention, the ink-jet printing operations further include depositing at least a third precursor by using at least a third nozzle of the ink-jet system.

According to an embodiment of the present invention, a pH value of the first precursors, the second precursor and the at least a third precursor is in a range between 0 and 7.

According to an embodiment of the present invention, a pH value of a mixture of the first precursors, the second precursor and the at least a third precursor is in a range from 0 to 7 after depositing the at least a third precursor.

According to an embodiment of the present invention, another chemical reaction occurs between the at least a third precursor and the first precursors or the second precursors.

According to an embodiment of the present invention, the ink-jet printing operations are performed for 10 times to 150 times.

Application of the metal compound thin film, the method of forming the same and the thin film catalyst of the present invention, which form the metal compound thin film on the substrate by using the ink-jet printing operation, thereby accomplishing patterning the thin film easily and saving the precursor solution affectively.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is an electrochemical examination result according to embodiment 1 of the present invention.

FIG. 2A illustrates various thin film patterns of embodiment 2.

FIG. 2B is an electrochemical examination result according to embodiment 2 of the present invention.

FIG. 3 is an XRD diagram of product of embodiment 3.

### DETAILED DESCRIPTION

The following disclosure provides many different embodiments, or examples, for implementing different features of the provided subject matter. As used herein, “around,” “about,” “approximately,” or “substantially” shall generally mean within 20 percent, or within 10 percent, or within 5 percent of a given value or range.

Compared to use a conventional roll-to-roll process or a lithography process to fabricate a metal oxide thin film, which exist disadvantages such as chemical solution consumption or complicated process, the present invention provides a metal compound thin film, a method of forming the same and a thin film catalyst. The metal compound thin film is formed on a substrate by ink-jet printing operations to easily accomplish patterning the metal compound thin film and affectively save a precursor solution.

The method of forming the metal compound thin film includes providing a substrate, and then performing at least one ink-jet printing operation on the substrate to form the metal compound thin film on the substrate. In some embodiments, since the ink-jet printing operation prints a solution on the substrate, the substrate should be a non-hydrophobic substrate, and a hydrophilic substrate is preferable. In some examples, the substrate can be a silicon wafer, a metal substrate, a polymer substrate or combinations thereof.

The ink-jet printing operation is performed by using an ink-jet system. In some embodiments, the ink-jet system is an ink-jet printer, in which the ink-jet printer includes nozzles and cartridges loaded with solution, and one nozzle connects to one cartridge, thereby spraying specific solution. In some embodiments, the ink-jet printer includes at least two nozzle and at least two cartridges to spray at least two types of solutions. In an example, the cartridges of the ink-jet printer can be replaced by syringe needles; thus, the syringe needles can be used to soak up precursor solutions and be installed on the ink-jet printer, thereby reducing process steps.

Each of the above ink-jet printing operations includes depositing a first precursor on the substrate by using a first nozzle; and then depositing a second precursor on the substrate by using a second nozzle. A chemical reaction can occur between the first precursor and the second precursor to form a layer of metal compound. Therefore, multiple times of ink-jet printing operations are repeated to form multiple layers of metal compounds, thereby forming the metal compound thin film described above on the substrate. In some embodiments, the first precursor and the second precursor are metal ion solutions. In some examples, the first precursor is potassium permanganate, while the second precursor is cobalt acetate, cobalt sulfate, ferric sulfate or other metal compounds capable of reacting with the first precursor. In some embodiments, a mixture of the first precursor and the second precursor is in a range from 0 to 7.

In some embodiments, after depositing the first precursor and the second precursor, the ink-jet printing operations further include depositing at least a third precursor on the substrate by using at least a third nozzle. In some embodiments, according to deposited position of the third precursor, the chemical reaction can occur between the third precursor and the exposed first precursor and/or the second precursor, thereby producing another metal compound. In other embodiments, the third precursor may not be reacting with the first precursor and the second precursor, but doping within the metal compound formed by the first precursor and the second precursor. It is understood that species and number of the metal compound of the metal compound film of the present invention are not limited, and it can be designed according to application requirement, for example, it can include 2 to 8 types of the metal compounds simultaneously. In some embodiments, the first precursor and the second precursor, as well as optionally the third precursor, are weak acid, a pH value of which is in a range between about 0 and about 7. Under environment of such pH value, the metal compound thin film may be easier deposited. In some embodiments, a mixture of the first precursor, the second precursor, and optionally the third precursor is in a range from 0 to 7. Generally, the pH value is about 3.38 to about 4.72 after mixing the various precursors. Such condition is suitable for deposition of the metal compound thin film, so it is no need to additionally add acid or alkali to adjust the pH value. In some embodiments, oxidation potentials of the first precursor and the second precursor (and optionally the third precursor) are different. In the aforementioned embodiments, the chemical reactions occurred between the first precursor and the second precursor (and optionally the third precursor) are spontaneous oxidation-reduction reaction; thus, it can occur without need of heating or other specific conditions. In other words, after the first precursor and the second precursor (and optionally the third precursor) are sprayed on the substrate under room temperature, they can contact with each other to react to form the metal compound. In some examples, the chemical reaction is acidic redox-assisted deposition (ARD). In other embodiments, the chemical reaction between the first precursor and the second precursor (and the third precursor) may occur with need of additional reaction conditions, which depends on reaction properties of various precursors. In addition, generally, the precursor used as an oxidant can influence adhesion of the metal compound onto the substrate, while another precursor used as a reductant determines efficacy of the metal compounds.

In some embodiments, the metal compound thin film includes a thin film pattern, and the desired thin film pattern depends on actual application requirements. Compared to the conventional patterning by using photoresist and the lithography, the present invention uses the ink-jet printing system to easily design the desired thin film pattern and deposit the precursor in a specific area by using the nozzle, thereby forming the metal compound layer in the specific area. In some embodiments, the thin film pattern can include one or multiple rectangular blocks, and each rectangular block does not contact with each other and is arranged regularly or irregularly on the substrate. The shape of the thin film pattern of the present invention is not limited to rectangle, but it can be adjusted according to application requirement. The thin film pattern can be adjusted according to its function or appearance. Taking a thin film catalyst as an example, the thin film pattern with regular arrangement is preferable since it shows better catalytic activity.

In some embodiments, after every one to ten times of the ink-jet printing operations, a rinsing operation is performed, in which the number of intervals (between two continuous rinsing operations) depends on the used precursor and/or reaction properties and adhesion of the produced metal compounds. The rinsing operation can include washing the substrate with deionized water to wash out the unreacted precursor solution, byproducts produced by the reaction or the metal compound with bad adhesion, thereby being beneficial to the adhesion and applicability of the obtained metal compound. In some embodiments, after the rinsing operation, a drying operation is optionally performed on the substrate. The drying operation can be performed by any known method, such as drying with a heat gun or purging with nitrogen, thereby removing moisture.

Each time of the ink-jet printing operations can form a layer of the metal compound. In some embodiments, the metal compound thin film can include 10 layers to 150 layers of the metal compound. Preferably, the metal compound thin film can include 50 layers to 150 layers of the metal compound. Compared to the multiple layers of thin film formed by the conventional method, the metal compound thin film of the present invention formed with the ink-jet printing operation shows better adhesion, and adhesion of the thin film can increase with increasing of the number of layers. Therefore, the metal compound thin film including the metal compounds in the aforementioned range of number of layers shows better adhesion and shows better catalytic activity as the thin film catalyst without need of consuming too much processing time.

The method of forming the metal compound thin film can be used to save more chemical solution, and the usage the chemical solution is only about 0.1 μL/cm². Moreover, since the ink-jet printing system is controlled by computer, adjustment of element ratio and patterning can be easily accomplished.

Water electrolysis is an electrochemical reaction whereby water is split into hydrogen and oxygen through the application of electrical energy. Anion exchange membrane (AEM) water electrolysis system is a reaction system under positive research currently. However, compared to the convention water electrolysis method, the catalyst of the AEM system still doesn't have enough catalytic activity, and mass transfer rate of hydroxide ions is slower, so current density of reaction is lower. Therefore, the present invention further provides a thin film catalyst for water electrolysis, which includes the metal compound thin film obtained by using the above method.

According to test results, the catalytic effect of the thin film catalyst is better when the thin film pattern includes smaller pattern and/or the thin film pattern is less continuous while having the same surface area of the thin film pattern. In addition, compared to those conventional stable thin film catalyst demanding additional organic additives, the thin film catalyst of the present invention does not require organic additives, thereby having better catalytic activity. Therefore, the process cost of the thin film catalyst can be decreased by the present invention, and the catalytic activity can be affectively increased, thereby affectively increasing reaction rate and current density of the water electrolysis reaction.

The following Embodiments are provided to better elucidate the practice of the present invention and should not be interpreted in anyway as to limit the scope of same. Those skilled in the art will recognize that various modifications may be made while not departing from the spirit and scope of the invention. All publication and patent applications mentioned in the specification are indicative of the level of those skilled in the art to which this invention pertains.

### Embodiment 1

Embodiment 1 deposited potassium permanganate (first precursor) and cobalt acetate (second precursor) on a fluorine-doped tin oxide (FTO) conductive glass to form a metal compound thin film of cobalt manganese hydroxide. The thin film catalyst with 10, 30, 50, 100 and 150 layers were fabricated, respectively, in which the FTO conductive glass was rinsed with the deionized water after the ink-jet printing operation for every ten times. In addition, comparative example synthesized the metal compound of potassium permanganate (first precursor) and cobalt acetate (second precursor) in a beaker, and then forming the catalyst with depositing on the FTO conductive glass. The catalytic effect of the thin film catalyst with various layers and the catalyst synthesized in the beaker were evaluated by the electrochemical examination method.

The following described the electrochemical examination method. First, the thin film catalyst was used as a working electrode in a three-electrode system, while platinum foil was used as a counter electrode, and Hg/HgO was used as a reference electrode. Electrolyte was potassium hydroxide in 0.1 M. Then, linear sweep voltammetry (LSV) was performed, in which a sweep rate was 50 mV/s.

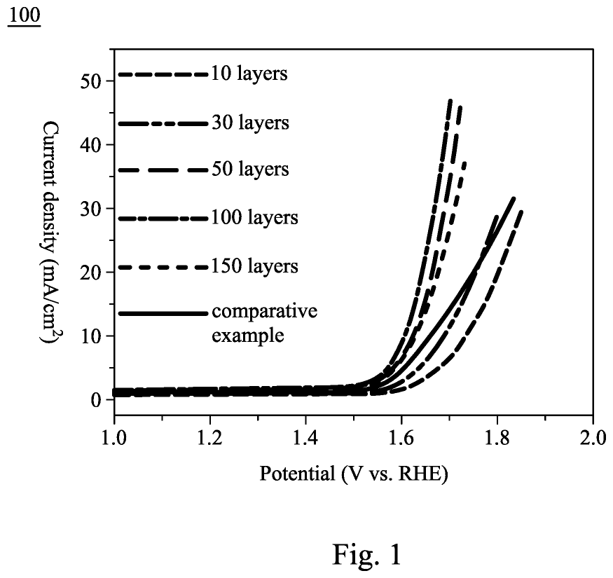

FIG. 1 was an electrochemical examination result 100 of embodiment 1. As shown in FIG. 1, the thin film catalyst with the metal compound of 50 layers and above had better catalytic effect, and catalytic ability of 50, 100 and 150 layers showed no significant difference.

### Embodiment 2

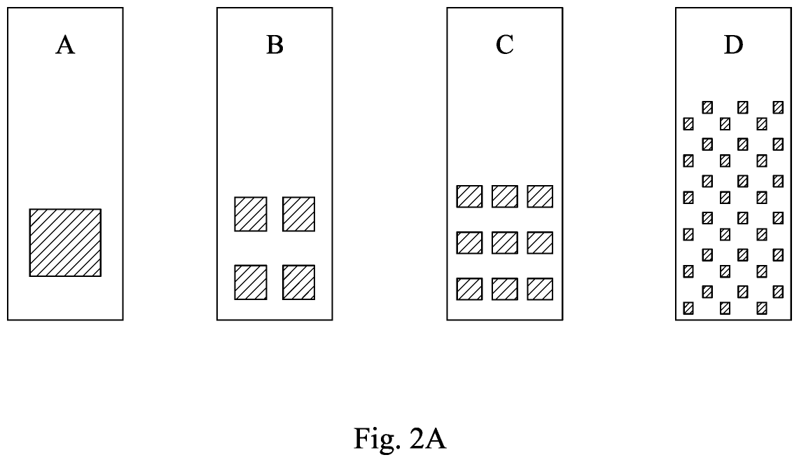

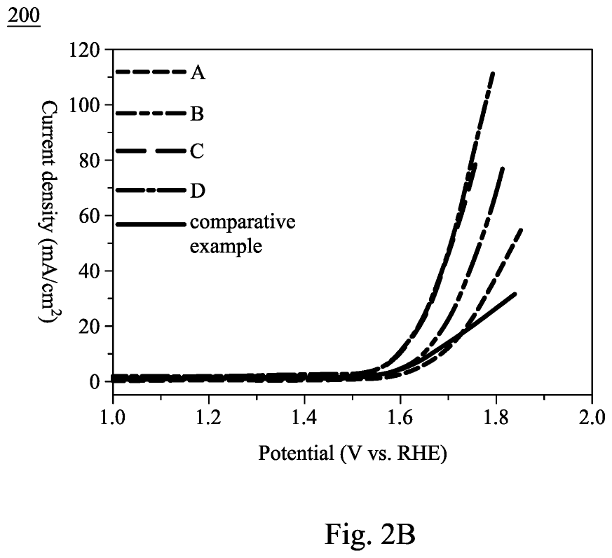

Embodiment 2 compared the catalytic effect of the thin film catalyst with different thin film pattern. FIG. 2A illustrated 4 kinds of thin film pattern of embodiment 2, in which sample A included one square with a side length of 0.6 centimeter; sample B included 4 squares with the side length of 0.3 centimeter; sample C included 9 squares with the side length of 0.2 centimeter; and sample D included 36 squares with the side length of 0.1 centimeter. Therefore, total area of the metal compound thin film for samples A to D were all 0.36 square centimeter with 50 layers of metal compound. Comparative example was the same as above, which was the catalyst fabricated by the metal compound synthesized in the beaker. Then, the catalytic effect of samples A to D and comparative example of the catalyst synthesized in the beaker were evaluated by the same electrochemical examination method as embodiment 1.

FIG. 2B was an electrochemical examination result 200 of embodiment 2. As shown in FIG. 2B, the catalytic ability was sample D>sample C>sample B>sample A>comparative example. Therefore, under the same thin film area, the catalytic effect was better while the area of single thin film pattern was smaller.

### Embodiment 3

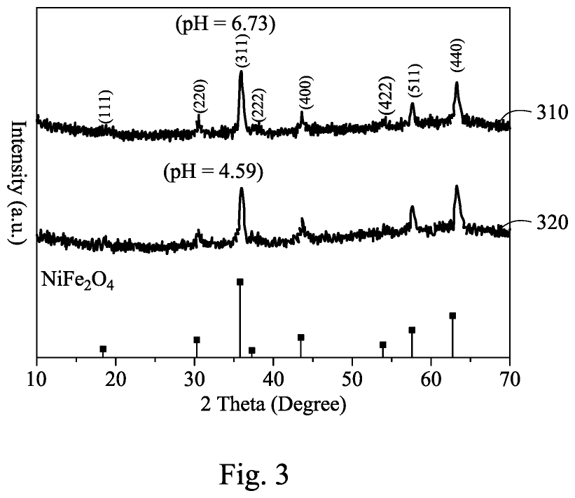

A first precursor and a second precursor are mixed to prepare a stable precursor mixture, and the precursor mixture of the first precursor and the second precursor had the pH value of 6.73. Referring to FIG. 3, FIG. 3 is an XRD diagram of product of embodiment 3. Product of NiFe₂O₄ was formed by reacting the first precursor and the second precursor in pH value of 6.73, as shown in line 310 of FIG. 3. In addition, when the pH value of the mixture of the first precursor and the second precursor was adjusted to 4.59 by adding 0.1 mL of acetic acid, NiFe₂O₄ was still formed, as shown in line 320 of FIG. 3. In other words, the same product can be formed by adjusting the pH value of the mixture of the first precursor and the second precursor in a specific range according to the product, for example, pH value of 4.59 to 6.73 for NiFe₂O₄.

According to above embodiments, the present invention provides the metal compound thin film and the method of forming the same, which uses the ink-jet printing operation to deposit multiple precursors capable of reacting with each other on the substrate, and the specific pattern was designed to form the metal compound thin film with the specific thin film pattern. By such method, the process can be simplified, the chemical solution consumption can be decreased enormously, and the element ratio can be adjusted according to application requirement. Moreover, the thin film catalyst including the metal compound thin film provided in the present invention can adjust thin film pattern and layers to obtain the catalyst with better catalytic ability.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method of forming a metal compound thin film, comprising:
providing a substrate, wherein the substrate is a non-hydrophobic substrate; and
performing at least one ink-jet printing operations to form the metal compound thin film on the substrate, wherein the metal compound thin film comprises at least a thin film pattern, and each of the ink-jet printing operations comprises:
depositing a first precursor on the substrate by using a first nozzle of an ink-jet system; and
depositing a second precursor on the substrate by using a second nozzle of the ink-jet system, wherein a chemical reaction occurs between the first precursor and the second precursor to form a metal compound, and the metal compound thin film comprises at least one layer of the metal compound.

2. The method of claim 1, wherein the substrate comprises a silicon wafer, a metal substrate, a polymer substrate or combinations thereof.

3. The method of claim 1, further comprising:
performing a rinsing operation after every one to ten times of the ink-jet printing operations, wherein the rinsing operation comprises washing the substrate with deionized water.

4. The method of claim 1, wherein the chemical reaction is an oxidation-reduction reaction, and oxidation potentials of the first precursor and the second precursor are different.

5. The method of claim 1, wherein each of the ink-jet printing operations further comprises:
depositing at least a third precursor by using at least a third nozzle of the ink-jet system.

6. The method of claim 1, wherein a pH value of the first precursor and the second precursor is in a range between 0 and 7.

7. The method of claim 1, wherein a pH value of a mixture of the first precursor and the second precursor is in a range from 0 to 7 after depositing a second precursor on the substrate.

8. The method of claim 1, wherein the at least a thin film pattern comprises a plurality of rectangular blocks, the rectangular blocks have no contact with each other, and are arranged regularly or irregularly.

9. A metal compound thin film formed by the method of claim 1.

10. A thin film catalyst for water electrolysis, comprising the metal compound thin film of claim 9.

11. A method of forming a metal compound thin film, comprising:
providing a substrate, wherein the substrate is a hydrophilic substrate;
performing a plurality of ink-jet printing operations to form the metal compound thin film on the substrate, wherein the ink-jet printing operations comprises:
depositing first precursors on the substrate by using a first nozzle of an ink-jet system; and
depositing second precursors on the substrate by using a second nozzle of the ink-jet system, wherein a chemical reaction occurs between the first precursors and the second precursors to form metal compounds, and the metal compound thin film comprises a plurality of layers of the metal compound; and
performing a rinsing operation to the substrate with deionized water.

12. The method of claim 11, wherein the substrate comprises a silicon wafer, a metal substrate, a polymer substrate or combinations thereof.

13. The method of claim 11, wherein the ink-jet printing operations further comprise:
depositing at least a third precursor by using at least a third nozzle of the ink-jet system.

14. The method of claim 13, wherein a pH value of the first precursors, the second precursor and the at least a third precursor is in a range between 0 and 7.

15. The method of claim 13, wherein a pH value of a mixture of the first precursors, the second precursor and the at least a third precursor is in a range from 0 to 7 after depositing the at least a third precursor.

16. The method of claim 13, wherein another chemical reaction occurs between the at least a third precursor and the first precursors or the second precursors.

17. The method of claim 11, wherein the ink-jet printing operations are performed for 10 times to 150 times.
